(19) United States
(12) Patent Application Publication
(10) Pub. No.: US 2003/0221432 A1
(43) Pub. Date: Dec. 4, 2003

(54) Solid fuel combustion method and apparatus for the conversion of waste into useful energy

(76) Inventor: Ronald M. Tucker, Green River, WY (US)

Correspondence Address: John E. Reilly, 1554 Emerson Street, Denver, CO, 80218, US

(21) Appl. No.: 10/161,854

(22) Filed: Jun. 3, 2002

(51) Int. Cl. F02C 3/28

(52) U.S. Cl. 60/781; 60/39.12

(57) ABSTRACT

Preferred and modified forms of a method and apparatus for converting waste into useful energy in which solid waste materials are fed through a single or parallel feed lines under constant pressure to a gasifier, at least partially combusted under pressure in the gasifier while constantly removing the ash from the gasifier, advancing the gases through a combuster stage for complete combustion, followed by delivering the combusted gases under pressure to a gas turbine and the like in order to generate power or perform other useful work.

### BACKGROUND AND FIELD OF INVENTION

This invention relates to a waste conversion method and apparatus, and more particularly relates to a novel and improved solid fuel-fired method and apparatus for supplying combustion gases to gas turbines.

Various types of solid fuel combustion systems have been developed for supplying combustion gases to power gas turbine engines. In the past, such systems have included a gasifier in which the fuel is combusted and converted into hot combustion gases under extremely high pressure. These gases will undergo expansion when introduced into the turbine or other prime mover in order to supply the necessary power for the turbine in driving a generator or for other power uses. Air locks have been used in the past to supply the solid fuel, such as, dry pulverized coal from a source of supply to the gasifier but are not capable of continuous feed without suffering a loss in pressure in the gasifier and combuster sections. Typically, such systems have been used with fluidized bed gasifiers and combusters, such as, shown and described in U.S. Pat. Nos. 4,530,207 to Brännström, 4,476,674 to Berman, 4,768,446 to Wilkes et al, 4,089,631 to Giles, 4,377,066 to Dickinson and 5,050,374 to Hunter. These systems require a means to separate or remove solids from the gas stream before entering the turbine thereby resulting in high pressure drops, low efficiency and performance. Another system shown in U.S. Pat. No. 4,409,786 features combustion of solids while entrained in a moving stream of air, but also requires solid separators with attendant high pressure drops.

There is an unmet need for a fixed bed gasifier with a constant feed dry fuel system which will maintain the desired pressure level of gases for operation of a gas turbine and is capable of operating efficiently with solid waste materials as a source of fuel.

### SUMMARY OF INVENTION

It is therefore an object of the present invention to provide for a novel and improved method for converting solid waste into useful energy and to a solid fuel combustion system for the conversion of waste to combustion gases to power gas turbines and the like.

It is another object of the present invention to provide for a novel and improved combustion system for gas turbines having a fixed bed gasifier and is characterized by its simplicity and efficiency; and further wherein the system is capable of delivering solid fuel at a constant rate while maintaining substantially constant pressure conditions in the gasifier.

It is a further object to provide for a novel and improved solid fuel combustion system for gas turbines which utilizes a unique combination of air locks, gasifier and combuster in such a way as to minimize the number of parts required along with a reduced size of gasifier and combuster for a given power output.

An additional object of this invention to provide a solid fuel delivery method and apparatus for a combustion system which is conformable for use with different fuel sources, such as, agricultural and municipal solid waste and coal in providing hot gases as a power source for generating mechanical or electrical power.

In accordance with the present invention, a solid fuel combustion system for generating power has been devised specifically for use in connection with gas turbines comprising a gasifier, a solid fuel source, means for delivering the solid fuel to the gasifier including parallel feed lines and at least one air lock between the delivery means and in the lines, and means for selectively feeding the solid fuel from each of the lines in succession to the gasifier in order to maintain the gasifier under constant pressure. The solid fuel is in pulverized form and is alternately delivered through each line to the gasifier. In a corresponding manner, the ash from the gasifier is alternately passed through two discharge lines in parallel to a collector so as to assist in maintaining a constant pressure in the gasifier. The gasifier and a combuster operate in unison to produce hot combustion gases which are delivered to power a gas turbine or perform other useful work.

The method of the present invention resides in generating mechanical or electrical power from solid combustible waste or other fuel by providing a source of dry pulverized fuel. Feeding the fuel continuously under constant pressure to a gasifier in which the fuel is ignited under pressure to be at least partially combusted into gases, advancing the gases to a combustion stage wherein the gases and any remaining fuel are caused to undergo complete combustion, followed by delivering the gases to a gas turbine or other device to produce mechanical or electrical power. The desired pressure is maintained in the system by alternately feeding the fuel though parallel feed lines to the gasifier and discharging the ash produced by the gasifier alternately through parallel discharge lines to a collector.

There has been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic view of a preferred form of solid fuel gas turbine in accordance with the present invention; and

FIG. 2 is a schematic view of a modified form of invention employing a single air lock.

### DETAILED DESCRIPTION OF PREFERRED EMBODIMENT

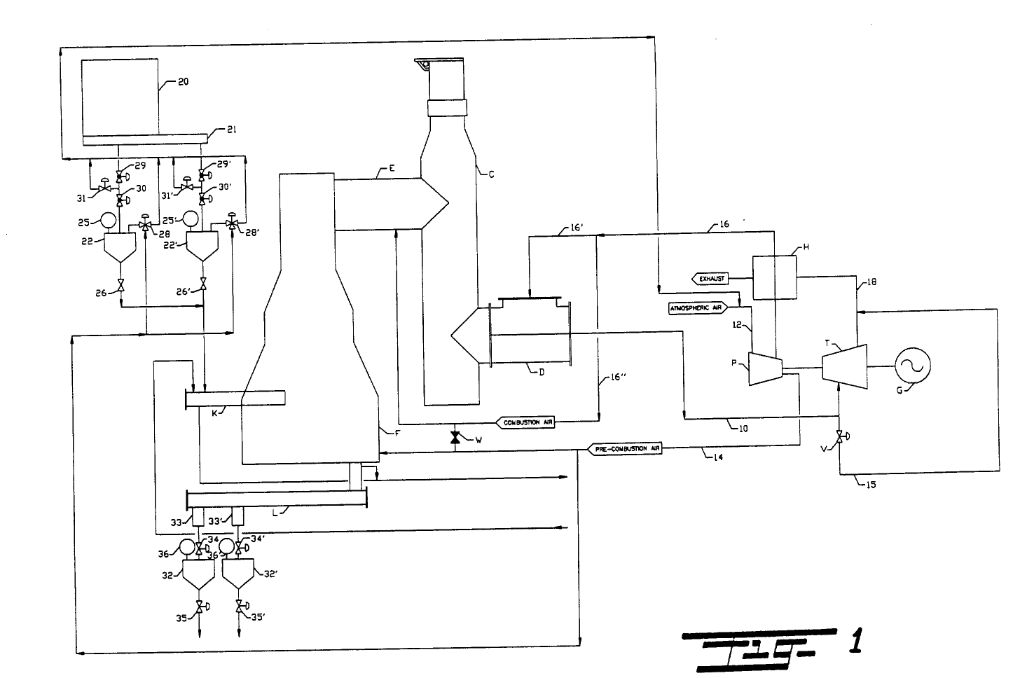

There is shown by way of illustrative example in FIG. 1 a solid fuel combustion system for a conventional gas turbine T which is drivingly connected to a generator G, the turbine T being powered by hot combustion gases via input line 10 from a suitable duct D. The duct D receives the hot gases from a fixed bed gasifier F wherein solid fuel is fired to form the gases and pass through an outlet duct E to a combuster C prior to exhaust through the duct D. A compressor P for the turbine T operates to compress outside air supplied over line 12, the compressed air being divided and delivered over a first line 14 as pre-combustion air to the gasifier F and over a second line 16 as combustion air through branch lines 16′ and 16″ to the outlet ducts D and E. The air via line 14 is metered into the gasifier F to partially combust the fuel but is controlled to prevent complete combustion and overheating of the gasifier components and to prevent entraining of particulate matter and ash into the gas stream. The air delivered via line 16 is added between the gasifier F and the gas turbine T to completely burn off the combustible gases from the gasifier F.

A commercially available gasifier F and combuster C are those manufactured and sold by PRM Energy Systems of Hot Springs, Arkansas, the particular models depending on size and fuel used. The gasifier F includes a feed conveyor K for introduction of the solid fuel at the inlet to the gasifier and an ash conveyor L for discharge of the ash into a suitable collector.

The turbine exhaust gases can be passed, through a line 18 to heat exchanger H to preheat the combustion air from the compressor P prior to its return over line 16 and increase the efficiency of the gasifier F. Operating speed may be controlled in a number of ways including but not limited to venting of gas upstream from the turbine T or metering a small amount of secondary fuel. In the case of a generator set connected to a utility grid, the generator can be operated by load control with speed being controlled by the generator and being synchronized to the grid.

The foregoing is given more by way of introduction and as a setting for the solid fuel combustion system of the present invention. For example, the gas turbine T and generator G are merely representative of various applications of the combustion system in furnishing pressurized gases as a power source. Nevertheless the system is particularly effective with gas turbines in maintaining a constant pressure of the hot gases over extended periods of operation in a manner now to be described.

In the invention shown in FIG. 1, a metering bin 20 for a solid fuel in the form of dry pulverized waste material is open to atmospheric pressure and includes a metering screw 21. The fuel is free to flow under gravity from one of two air locks 22 and 22′ connected in parallel through valve 26 or 26′ into the feed conveyor K. Assuming that the fuel is flowing from the air lock 22 through open valve 26 to the gasifier F, a level sensor 25 will sense a low fuel/coal level and close valve 26, The valve 26′ for the second air lock 22′ is simultaneously opened to allow the continuous feed of fuel to the conveyor K until the level sensor 25′ senses a low level condition.

In order to refill the first air lock 22, a valve 28 is switched to allow the release of pressure from the air lock 22. After the valve 26 is closed. Series-connected valves 29 and 30 in the feed line 23 are opened, and the metering screw 21 for the bin 20 is activated so that the waste or other fuel is free to flow by gravity into the air lock 22 in preparation for the next feed cycle while the second air lock 22′ is being emptied. The sensor 25 will sense when the air lock 22 is full and close the valves 29 and 30 as well as to stop the screw 21; and valve 31 is opened to bleed off any pressure between the valves 29 and 30.

The second air lock 22′ and associated control circuit of course alternate with the first air lock in feeding the fuel to the conveyor K and thereafter being filled in preparation for the next cycle. After each air lock 22 or 22′ is filled as described, the associated valve 26 or 26′ is closed and valve 28 or 28′ is switched to pressurize the respective air lock, and that valve 26 or 26′ for the filled air lock 22 or 22′ is opened to initiate the next feeding cycle.

In a manner similar to the feed cycle described, another pair of air locks 32 and 32′ are connected in parallel to discharge ports 33 and 33′ of the ash conveyor L. Thus, assuming that the air lock 32 is full of ash, the valve 34 is closed and valve 35 opened to permit the ash to flow with the assistance of compressed air from the air lock 32 into a suitable collector or receptacle. Level sensor 36 will sense when the air lock 32 is empty at which point valve 34 closes and valve 34′ opens. As the ash is emptied from air lock 34, ash will have flowed from the port 33′ through open valve 34′ into the air lock 32′ and is retained by closed valve 35. When sensor 36′ senses that the air lock 32′ is full it will close the valve 34′ and open valve 35′ to empty the air lock 32′ while the air lock 32′ is being refilled. Accordingly the process will continuously reverse itself and, in cooperation with the air locks 22 and 22′, maintain a constant pressure level in the gasifier F and combuster C to enable the supply of gases at a constant pressure to the gas turbine T.

In operation, waste material or other solid fuel is introduced from the metering bin 20 into the gasifier F as described and ignited. The gas turbine T is driven at a reduced speed by a suitable starter which will disengage when the turbine T produces enough power to sustain itself. Air from the compressor side of the turbine T will be metered into the gasifier F to partially combust the fuel and to drive off any combustible gas. Air flow in the first stage of combustion is controlled to prevent complete combustion and overheating of gasifier components as well as to prevent entraining particulate matter and ash into the gas stream. Additional combustion air is supplied over line 16″ to the duct E to burn off the combustible gases from the gasifier F. A suitable proportioning or metering valve W between the lines 14 and 16′ will regulate the relative amounts of air supplied to the gasifier F and duct E. As with a conventional gas turbine, expansion of the hot gases through the turbine T will provide the necessary power to perform useful work through the generator G. The turbine exhaust can be directed through the heat exchanger H to preheat the combustion air and increase efficiency. The exhaust may be augmented by excess combustion gases drawn off through a dump valve V through bypass line 15 into the exhaust line 18. Thus, the dump valve V will assist in controlling the speed of the turbine, and this speed may also be controlled by other means, such as, metering secondary fuel into the turbine T to control its operating speed.

From the foregoing, the method and apparatus of the present invention are extremely versatile in terms of regulating power and speed of a prime mover, such as, a gas turbine. Among other applications than those described, the method and apparatus are readily conformable for use in place of steam turbines while providing the following advantages:

a) Since combustion air will be under fairly high pressure, air density will be higher and the gasifier can be made considerably smaller for the same power output.

b) In size ranges from a few hundred to a few thousand horsepower, capital costs of a gas turbine power unit are much lower than for a steam power plant of equivalent power.

c) Operation of the gas turbine power unit is easier and requires less training than operation of a steam power plant.

### Detailed Description of Modified Form of Invention

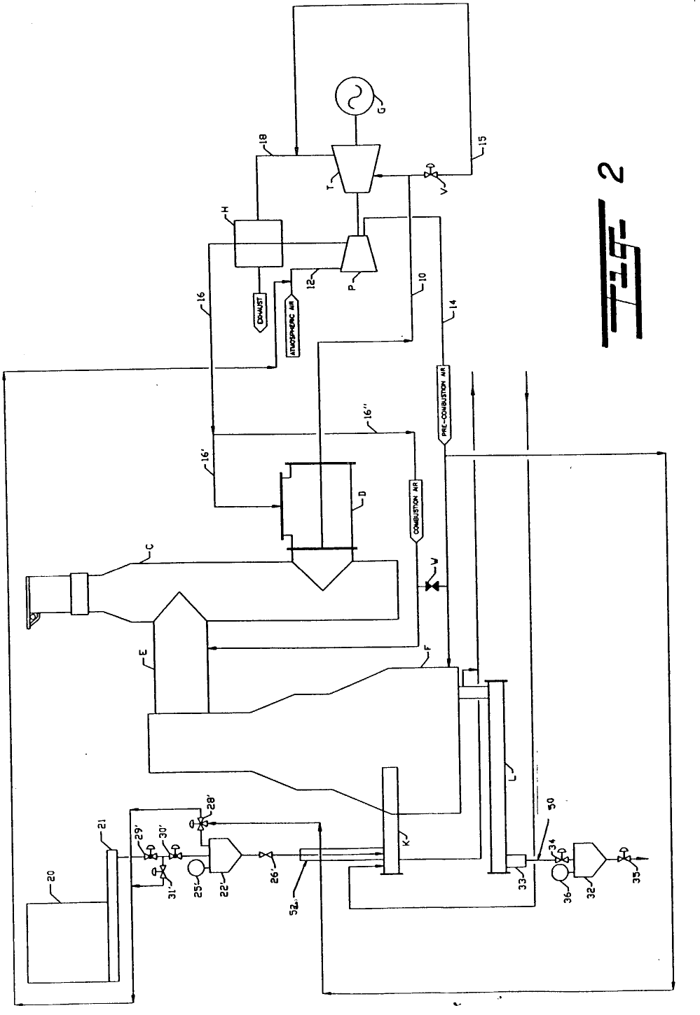

In certain applications, it is possible to employ a single air lock 22 or 22′ if the line or chute between the valve 26 and the screw conveyor K has sufficient volume to provide fuel to the gasifier while the air lock is being refilled. For example, as illustrated in FIG. 2, like parts to those of FIG. 1 are correspondingly enumerated. The large diameter chute 50 as shown in exaggerated size between valve 26′ and screw conveyor K will be full of fuel and will be of sufficient volume to feed the gasifier for at least the amount of time required to fill air lock 22′ with fuel. During filling of the air lock 22′, valve 26′ will be closed, valves 29′ and 30′ will be open, bleed valve 31′ will be closed, three-way valve 28′ will be turned to air lock vent 22′ to compressor inlet. As soon as air lock 22′ is full, valves 29′ and 30′ will close, valve 31′ will open, valve 28′ will switch to re-pressurize air lock 22′ and valve 26′ will open. When air lock 22′ is empty, the chute 50 between the valve 26′ and the conveyor K will be full and valves 26′, 28′, 29′, 30′ and 31′ will revert back to the starting position so that the air lock 22′ will refill. During the refilling cycle, the gasifier F will run off of the fuel remaining in conveyor K and in the chute 52 between valve 26′ and conveyor K. Valve 31 is simply a bleed to prevent air leaking past 29′ and 30′ from fluidizing fuel in 20. Three-way valve 28′ depressurizes air lock 22′ for filling and re-pressurizes air lock 22′ for emptying. The discharge air lock 32 will work in the same way except that since there is no need to prevent fluidizing a feed bin, fewer valves can be used. In practice, air pressure in air lock 32 will force ash out through large capacity chute 52 between the screw conveyor L and valve 34 as soon as the valve 35 opens.

A possible disadvantage is that utilization of a single air lock would require greater head room in an actual installation. In the systems herein described, the gasifier F can be smaller for the same power output requirements since more air can be drawn through the gasifier bed for a given velocity of air flow. Thus, more fuel can be consumed per unit of time and more power can be produced similar to deriving more power from a gasoline engine by turbocharging. In essence, the system operates as a turbocharged gasifier and for that reason the gasifier F must be built to withstand high pressures. Nevertheless, the gasifier F can be smaller and power extracted directly from the turbine T.

Referring again to use of the system in place of a steam turbine, capital costs are substantial lower than by burning fuel to produce steam for driving a steam turbine. Steam power also requires, at a minimum, a boiler, a deaerator, a turbine, feed water pumps, water treatment system, condensers and freeze protection.

The method and system of the present invention may be operated with various fuel sources including but not limited to agricultural waste, coal, wood chips, waste paper and municipal solid waste. For the purpose of illustration but not limitation, typical temperature levels at the gasifier are 800°-900° F.; 1800°-2000° F. in the combuster and turbine inlet; 1000° F. at the turbine exhaust; and 600°-700° F. at the compressor discharge.

It is therefore to be understood that the above and other modifications and changes may be made in the method and apparatus of the present invention without departing from the spirit and scope of the invention as defined by the appended claims and reasonable equivalents thereof.

I claim:

1. A solid fuel combustion system for a gas turbine comprising:
a gasifier;
a source of solid fuel;
means for delivering said solid fuel from said source to said gasifier including a pair of feed lines connected in parallel between said source and said gasifier and at least one air lock in said feed lines; and
means for selectively feeding said solid fuel from each of said feed lines in succession to said gasifier whereby to maintain said gasifier under pressure.

2. A combustion system according to claim 1 wherein each of said feed lines includes one of said air locks and said delivery means includes means for selectively delivering a first portion of said solid fuel from said source to one of said air locks when a second portion of said solid fuel is being delivered from the other of said air locks to said gasifier.

3. A combustion system according to claim 1 including an ash conveyor and means for delivering ash from said gasifier to said ash conveyor.

4. A combustion system according to claim 3 wherein another air lock is connected to said ash conveyor.

5. A combustion system according to claim 4 wherein a pair of said other air locks are connected in parallel to said ash conveyor and means for alternately discharging ash from said ash conveyor to each of said other air locks.

6. A combustion system according to claim 5 including means for alternately discharging said ash which is delivered to each of said other air locks.

7. A combustion system according to claim 1 wherein said gasifier includes means for igniting said solid fuel to produce hot combustion gases, and means for delivering said hot combustion gases to said gas turbine.

8. A combustion system according to claim 7 wherein combuster means is connected to said gasifier for removal of any combustible gases from said hot combustion gases prior to delivery to said gas turbine.

9. A combustion system according to claim 7 wherein means are provided for supplying pre-combustion air to said gasifier.

10. A combustion system according to claim 7 wherein means are provided for recirculating gases from said gas turbine to said combuster means and to a discharge end of said gasifier upstream of said combuster means.

11. A solid fuel combustion system for a gas turbine comprising:
a gasifier;
a source of solid fuel;
means for delivering said solid fuel from said source to said gasifier including a first pair of air locks connected in parallel between said source and said gasifier;
means for selectively feeding said solid fuel from each of said air locks in succession to said gasifier whereby to continuously feed fuel under pressure to said gasifier; and
discharge means including an ash conveyor and means for continuously removing ash from said ash conveyor while maintaining a constant pressure in said gasifier.

12. A combustion system according to claim 11 wherein said delivery means includes first means for selectively delivering a first portion of said solid fuel from said source to one of said air locks when a second portion of said solid fuel is being delivered from the other of said air locks to said gasifier.

13. A combustion system according to claim 12 wherein said discharge means includes a second pair of air locks connected in parallel to said ash conveyor and means for alternately discharging ash from said ash conveyor to each of said other air locks.

14. A combustion system according to claim 13 including means for alternately discharging said ash which is delivered to each of said second pair of air locks.

15. A combustion system according to claim 11 wherein said gasifier includes means for igniting said solid fuel to produce hot combustion gases, and means including a combuster for delivering said hot combustion gases to said gas turbine.

16. A combustion system according to claim 15 wherein said combuster is connected to said gasifier for removal of any combustible gases from said hot combustion gases prior to delivery to said gas turbine, and means for supplying pre-combustion air to said gasifier.

17. A combustion system according to claim 16 wherein means are provided for recirculating gases from said gas turbine to said combuster and to a discharge end of said gasifier upstream of said combuster means.

18. A method for converting solid waste into useful energy comprising the steps of:
providing a source of dry solid pulverized waste;
feeding said waste continuously under pressure to a gasifier in which said waste is ignited under pressure to at least partially combust said waste into gases;
advancing said gases to a combustion stage wherein said gases and waste are caused to undergo complete combustion; and
converting said combustion gases to electrical power.

19. The method according to claim 18 characterized by the step of alternately feeding said waste to said gasifier through parallel feed lines and maintaining said waste under constant pressure.

20. The method according to claim 18 including the step of discharging ash formed in said gasifier through alternate discharge lines while maintaining said gasifier under constant pressure.
